(19) United States
(12) Patent Application Publication
(10) Pub. No.: US 2009/0020693 A1
(43) Pub. Date: Jan. 22, 2009

(54) CHROMATOGRAPH MASS ANALYSIS DATA PROCESSING APPARATUS

(75) Inventor: Shinichi YAMAGUCHI, Kyoto-shi (JP)

Correspondence Address: SUGHRUE MION, PLLC, 2100 PENNSYLVANIA AVENUE, N.W., SUITE 800, WASHINGTON, DC, 20037, US

(73) Assignee: SHIMADZU CORPORATION, Nakagyo-ku (JP)

(21) Appl. No.: 12/173,399

(22) Filed: Jul. 15, 2008

(30) Foreign Application Priority Data
Jul. 18, 2007 (JP) 2007-186424

(51) Int. Cl. H01J 49/26; G06F 19/00

(52) U.S. Cl. 250/281; 702/27

(57) ABSTRACT

The invention provides a chromatograph mass analysis data processing apparatus in which operators can easily obtain information about plural compounds that characterize a difference between plural samples on the basis of the result of a multivariate analysis. A set of data collected by LC/MS analyses of plural samples is subjected to a multivariate analysis (principal component analysis) to create and display a loadings plot. On this loadings plot, the operator can specify a range A to select one or more characteristic data points that seem influential in the grouping of the plural samples. In response to this operation, one or more markings B indicating the peaks corresponding to the data points selected within the range A are displayed on an isointensity line graph whose two axes indicate the retention time and mass-to-charge ratio. These markings enable the operator to check, for example, that the compounds that are influential in the grouping of the samples belong to a specific compound series.

The present invention relates to a chromatograph mass analysis data processing apparatus for processing data collected by a chromatograph mass spectrometer, such as a gas chromatograph mass spectrometer (GC/MS) or liquid chromatograph mass spectrometer (LC/MS).

### BACKGROUND OF THE INVENTION

In chromatograph mass spectrometers such as a GC/MS and LC/MS, data having three dimensions, i.e. a retention time, mass-to-charge ratio, and signal intensity, is collected. The data collected is processed to create a mass chromatogram, mass spectrum, and total ion chromatogram. The mass chromatogram shows the relationship between the retention time and the signal intensity for a specified mass-to-charge ratio, the mass spectrum shows the relationship between the mass-to-charge ratio and the signal intensity for a specified retention time, and the total ion chromatogram shows the relationship between the retention time and the signal intensity without the limitation of mass-to-charge ratio.

In recent years, chromatograph mass spectrometers have been used in various fields, such as the research and development of medical supplies or agrichemicals, and the research of biopolymers. In these activities, a large number of samples are analyzed with chromatograph mass spectrometers to obtain multivariate data consisting of many kinds of interrelated characteristic values, and these data are analyzed using various kinds of multivariate analysis techniques, such as discrimination analysis, factor analysis, cluster analysis, soft independent modeling of class analogy (SIMCA) method, partial least square (PLS) method, orthogonal PLS (O-PLS) method, k nearest neighbors (KNN) method, and principal component analysis (PCA). For example, Non-Patent Document 1 discloses a software program for processing mass analysis data by the PCA method. Non-Patent Document 2 shows another example, in which mass analysis data of plural samples are processed by the PCA method and the results are presented using the charts called the “scores plot” and “loadings plot”. The scores plot presents PCA analysis results in such a manner that enables users to easily recognize the grouping of plural samples. The loadings plot provides information about which compounds (components) contribute to the grouping of those samples and to what extent.

However, the axes used in these charts merely indicate mathematically invented values, which have no relation with the actual mass-to-charge ratio or retention time of the analyzed compounds. Presenting the results of principal component analysis in such an imaginary form does not enable operators to quickly obtain concrete information, e.g. the information about the interrelationship of the compounds that are influential in the grouping of the plural samples.

Non-Patent Document 1: “MarkerView™ Software for Metabolomic and Biomarker Profiling Analysis”, Applied Biosystems, Internet <http://www3.appliedbiosystems.com/cms/groups/psm_marketing/documents/generaldocu ments/cms_{—}042026.pdf>, [May 27, 2008]

Non-Patent Document 2: Jun YONEKUBO et al., “Saishin No Hikoujikan-gata Shitsuryobunseki-kei LCT Premier™ No Tokuchou To Shokuhin Metaborohmu Heno Ouyou (Feature of newest Time-Of-Flight Mass Spectrometer LCT Premierm and Its Applied for Food Metabolome)”, Chromatography, Vol. 27, No. 2(2006), Internet <URL: http://wwwsoc.nii.acjp/scs/Journal/pdf/27-2_{—}085.pdf>, [Jun. 28, 2007]

In view of the aforementioned problem, an objective of the present invention is to provide a chromatograph mass analysis data processing apparatus capable of providing, in a simple yet efficient manner, useful information about plural samples, such as their structural differences or similarities, on the basis of a multivariate analysis of a set of data obtained through a chromatograph mass analysis.

### SUMMARY OF THE INVENTION

To solve the previously described problem, the present invention provides a chromatograph mass analysis data processing apparatus for processing data collected by a chromatograph mass spectrometer in which a chromatograph for separating a sample into components and a mass spectrometer for mass-analyzing the sample components separated by the chromatograph are combined, including:

a) a graph creator for creating, for each sample, a graph having a retention time and a mass-to-charge ratio on two axes on a plane with a signal intensity represented in contour or represented by an intensity-discriminable expression equivalent to the contour, on the basis of data collected by a chromatograph mass analysis of one or more samples;

b) a multivariate analysis result displayer for performing a multivariate analysis of the data collected by the chromatograph mass analysis of the aforementioned one or more samples, and for displaying the result of the multivariate analysis;

c) a point selector for allowing a user to select one or more data points, or a range including one or more data points, on the result of the multivariate analysis displayed by the multivariate analysis result displayer; and

d) a graph display processor for displaying the graph created by the graph creator, superposing an indicator on the graph to indicate which member or members of the data collected by the chromatograph mass spectrometer correspond to the aforementioned one or more data points selected by the point selector or included in the range selected by the point selector.

Typically, the chromatograph mass spectrometer used in the present invention is a liquid chromatograph mass spectrometer or a gas chromatograph mass spectrometer. The mass spectrometer may be any type as long as it is capable of separating and detecting ions according to the mass-to-charge ratio. The means for the mass separation may be, but not specifically limited to, a quadrupole mass filter or a time-of-flight mass analyzer.

Preferably, the multivariate analysis method may be, but not limited to, a principal component analysis (PCA), partial least square (PLS), soft independent modeling of class analogy (SIMCA), or orthogonal PLS (O-PLS).

For example, in the case where a principal component analysis has been performed on a set of data collected by a chromatograph mass analysis for each of a large number of samples, each data point on a scores plot represents each sample, while each data point on a loadings plot represents a compound (or component) contained in one or more of the samples. Therefore, selecting a specific data point or any range including plural data points on the loadings plot showing the result of a multivariate analysis can be interpreted as selecting one or more specific compounds. This selection is performed using the point selector, which, for example, is designed for users to select individual data points by a clicking operation of a pointing device (e.g. a mouse) or specify the aforementioned range by creating a frame of an appropriate shape and size by a drag or similar operation of the pointing device.

An example of the graph created by the graph creator is an “isointensity line graph” having the retention time and mass-to-charge ratio on two orthogonal axes with the signal intensity represented in contour. Any compound contained in a sample should have a peak located at a specific retention time and with a specific mass-to-charge ratio. Accordingly, any of the aforementioned one or more compounds selected by the point selector always has a peak located on at least one of the isointensity line graphs each corresponding to a different sample. The graph display processor superposes a predetermined marking on the isointensity line graph in such a manner that enables the operator to identify each peak that corresponds to each of the compounds selected on the isointensity line graph.

In the case where the grouping of the plural samples is significantly influenced by plural compounds with similar structures that belong to a specific compound series, data points corresponding to the plural compounds will be uniquely located on the loadings plot (normally, at a large distance from the origin). If the operator (user) selects these data points, a series of markings will appear on the aforementioned graph (e.g. an isointensity line graph) along a straight line, which distinctively indicates the compound series concerned. These markings help the operator realize that a specific compound series has a significant influence on the differences in the nature and structure of the plural samples.

Thus, the chromatograph mass analysis data processing apparatus according to the present invention enables users to obtain useful information about the compounds contained in target samples by performing simple tasks with simple operations on the basis of a multivariate analysis result.

### BRIEF DESCRIPTION OF THE DRAWINGS

FIG. 1 is a schematic diagram of a liquid chromatograph mass spectrometer (LC/MS) according to an embodiment of the present invention.

FIG. 2 is a block diagram showing the configuration of the functional sections characteristic of the LC/MS of the embodiment.

FIG. 3 is an example of the isointensity line graph created by the LC/MS of the embodiment.

FIG. 4A is an example of the scores plot created by the LC/MS of the embodiment, and FIG. 4B is an example of the loadings plot created by the same LC/MS.

FIGS. 5A and 5B are explanatory charts illustrating a characteristic operation of the LC/MS of the embodiment.

### EXPLANATION OF THE NUMERALS

1 . . . Liquid Chromatograph
2 . . . Mobile Phase Container
3 . . . Liquid Sending Pump
4 . . . Injector
5 . . . Column
10 . . . Mass Analyzer
11 . . . Ionization Chamber
12 . . . Electrospray Nozzle
13 . . . Heating Pipe
14 . . . First Intermediate Vacuum Chamber
15 . . . First Ion Lens
16 . . . Skimmer
17. . . Second Intermediate Vacuum Chamber
18 . . . Second Ion Lens
19 . . . Analysis Chamber
20 . . . Quadrupole Mass Filter
21 . . . Ion Detector
22 . . . A/D Converter
23 . . . Data Processor
24 . . . Data Memory
25 . . . Controller
26 . . . Input Unit
27 . . . Display Unit
30 . . . Multivariate Analysis Operator
31 . . . Score Calculator
32 . . . Covariance Matrix Generator
33 . . . Loading Calculator
34 . . . Isointensity Line Graph Creator
35 . . . Scores Plot Creator
36 . . . Loadings Plot Creator
37 . . . Component Selector
38 . . . Indication Symbol Creator
39 . . . Superposing Processor
40 . . . Input/Output Interface

### DETAILED DESCRIPTION OF A PREFERRED EMBODIMENT

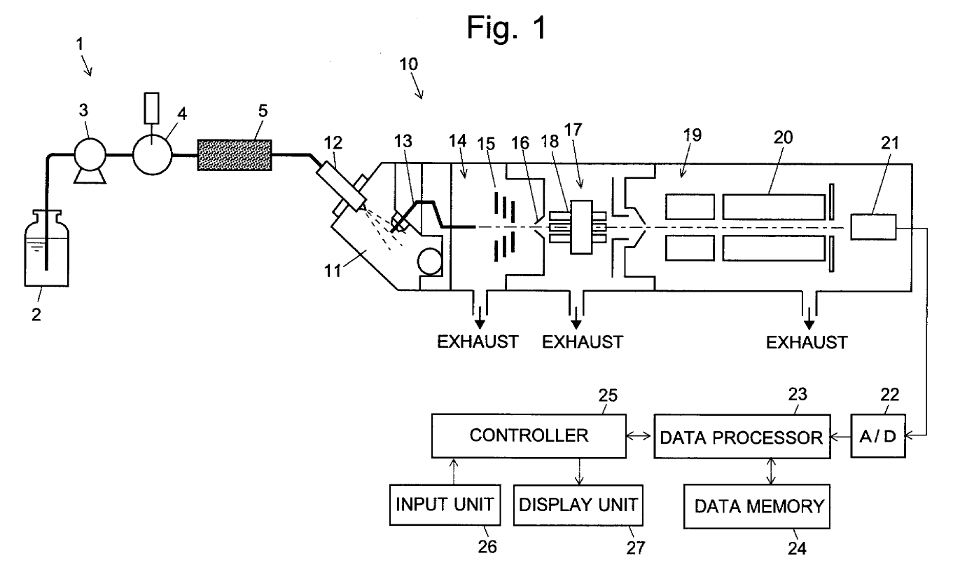

As an embodiment of the present invention, a liquid chromatograph/mass spectrometer (LC/MS) coupled with a data processing apparatus according to the present invention is described with reference to the attached drawings. FIG. 1 is a schematic diagram of the LC/MS according to the present embodiment.

In the liquid chromatograph 1, a mobile phase held in a mobile phase container 2 is siphoned at an approximately constant flow rate by a liquid sending pump 3 to be provided to a column 5. The sample to be analyzed is introduced to the mobile phase from an injector 4 at a predetermined timing. The sample on the mobile phase is sent into the column 5. While passing through the column 5, various components included in the sample are temporally separated to be eluted from the column 5 in series. The sample liquid including these eluted sample components is introduced to the mass spectrometer 10.

The sample liquid is sprayed into the ionization chamber 11 at an atmosphere of approximate atmospheric pressure from the electrospray nozzle 12, which ionizes the component molecules in the sample liquid. The ions generated are sent into the first intermediate vacuum chamber 14, which is in a low vacuum atmosphere, by way of a heating pipe 13. In the ionization chamber 11, other atmospheric ionization methods such as an atmospheric chemical ionization can be used other than the electrospray ionization method. Alternatively, such methods may be combined. Whatever the case may be, the ions are sent into the second intermediate vacuum chamber 17, which is in a medium vacuum atmosphere, via a small opening formed on top of a skimmer 16, while being converged by the first ion lens 15 arranged inside the first intermediate vacuum chamber 14. Then the ions are sent into the analysis chamber 19, which is in a high vacuum atmosphere, while being converged by an octapole-type second ion lens 18 arranged inside the second intermediate vacuum chamber 17.

In the analysis chamber 19, only the ions having a specific mass (mass-to-charge ratio m/z to be exact) fly through the longitudinal space of the quadrupole mass filter 20, and ions having other masses are dispersed along the way. The ions that have flown through the quadrupole mass filter 20 reach an ion detector 21, and then the ion detector 21 provides an ion intensity signal corresponding to the ions' amount. This ion intensity signal is converted to a digital value by an A/D converter (analog to digital converter) 22 and then provided to a data processor 23. The data processor 23 creates a mass spectrum, mass chromatogram, total ion chromatogram. Based on such results, the data processor 23 performs a qualitative analysis, quantitative analysis, or other analyses. The data processor 23 includes a data memory 24 which stores and saves the data collected by the LC/MS.

To the controller 25 for controlling each unit in order to perform a mass analyzing operation as previously described, an input unit 26, such as a keyboard and mouse, and a display unit 27, such as an LCD (liquid crystal display) are connected. The substance of the data processor 23 and the controller 25 is a personal computer. When the personal computer performs a dedicated control/processing program installed on the personal computer, the functions of the data processor 23 and the controller 25 are realized.

In the LC/MS having the aforementioned configuration, the mass of the ions that are allowed to fly through the quadrupole filter 20 is determined according to the voltage applied to the quadrupole filter 20. Hence, if the voltage applied to the quadrupole filter 20 is repeatedly scanned in a predetermined range from the point in time of the sample's injection (that is, a scan measurement is performed), mass spectrums in a predetermined mass range can be repeatedly obtained as time progresses. Thus the data having three dimensions of a retention time, mass-to-charge ratio, and signal intensity can be collected. The data collected with regard to one sample is stored in the data memory 24 as one file.

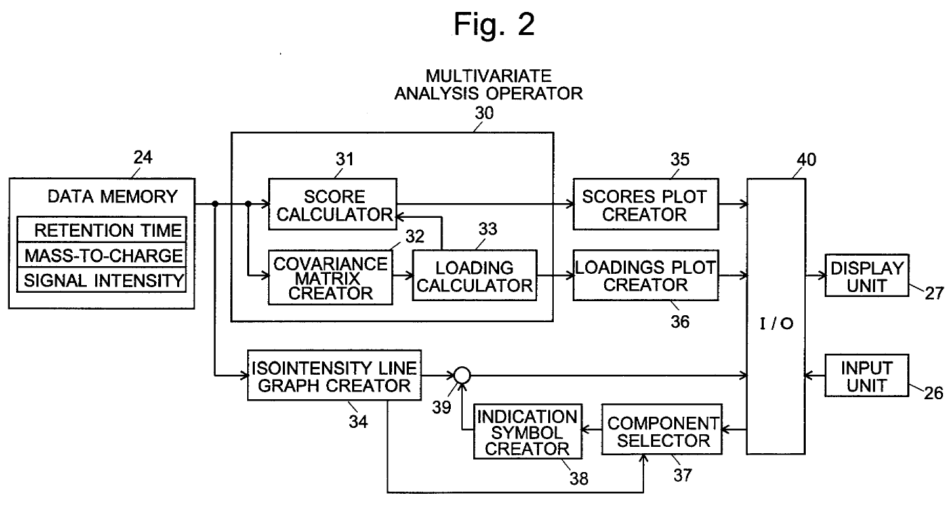

FIG. 2 is a block diagram showing functional sections included in the data processor 23 and the controller 25, which perform operations characteristic of the LC/MS of the embodiment. The data memory 24 has a previously-stored set of data collected by a series of LC/MS analyses separately performed on each of a large number of samples. As explained earlier, each data has three dimensions: the retention time, mass-to-charge ratio and signal intensity.

The aforementioned data are read out from the data memory 24 and sent to the multivariate analysis operator 30 and the isointensity line graph creator 34. There are various kinds of multivariate analysis techniques generally known and used. The present embodiment assumes that the multivariate analysis operator 30 uses the principal component analysis. This technique uses fewer indices (which is two in the present embodiment) to represent many variables. The present specification will omit detailed description of the technique of principal component analysis. For more information, refer to Yoshikatsu MIYASHITA and Shin-ichi SASAKI, Chemometrics, KYORITSU SHUPPAN CO., LTD., Tokyo (1995) and other literatures. The computing operations that are necessary for the multivariate component analysis can be performed on personal computers or workstations using various kinds of software programs available on the market, e.g. the aforementioned MarkerView™ Software.

In the multivariate analysis operator 30, the covariance matrix generator 32 processes measured data of a given set of plural samples to create a covariance matrix, which is a kind of correlation matrix. The loading calculator 33 calculates the loading for each component from the covariance matrix. Based on the measured data of the plural samples and the computed loadings, the score calculator 31 calculates a score for each sample. The loadings plot creator 36 produces a loadings plot in which the calculated loadings are plotted on a graph having two orthogonal axes representing two principal components. The scores plot creator 35 produces a scores plot in which the calculated scores are plotted on a graph having two orthogonal axes representing two principal components.

Based on the measured data of the plural samples, the isointensity line graph creator 34 creates, for each sample, a two-dimensional isointensity line graph in which the retention time is indicated by the abscissa axis and the mass-to-charge ratio by the coordinate axis, with the signal intensity represented in contour.

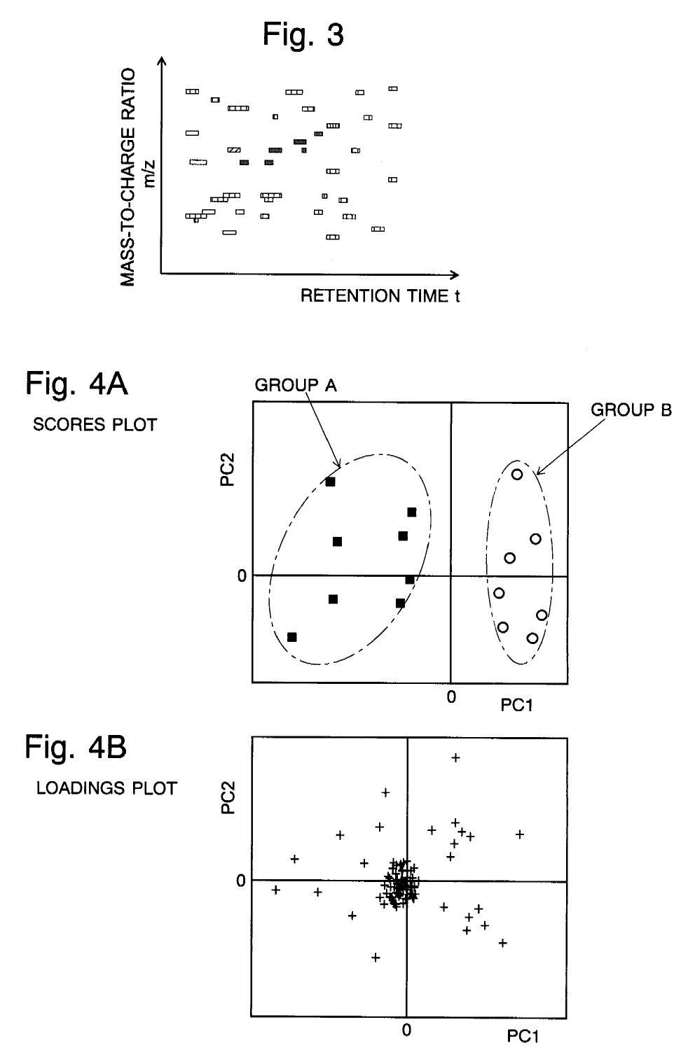

When an operator performs a predetermined operation on the input unit 26 to enter a command for displaying the result of the multivariate analysis, a scores plot created by the scores plot creator 35 and a loadings plot created by the loadings plot creator 36 are displayed through the input/output (I/O) interface 40 on the screen of the display unit 27, as shown in FIGS. 4A and 4B. When the operator performs a predetermined operation on the input unit 26 to enter a command for displaying the isointensity line graph of a specific sample, an isointensity line graph created by the isointensity line graph creator 34 is displayed through the I/O interface 40 on the screen of the display unit 27, as shown in FIG. 3. As already explained, an isointensity line graph is prepared for each sample. Accordingly, there are as many isointensity line graphs as plural samples. Those graphs may be presented in any form. For example, plural graphs may be simultaneously displayed on the screen. Alternatively, the graphs may be displayed one after another.

On the scores plot shown in FIG. 4A, the data points (indicated by the circles and filled squares in this example) each represent a separate sample. From their positional relationship, the plural samples can be divided into groups, as shown. Specifically, in the present case, the plural samples are divided into two groups “A” and “B.”

On the loadings plot shown in FIG. 4B, the data points (indicated by the crosses in this example) each correspond to each variable collected by the LC/MS analysis. In other words, each data point represents a component contained in at least one sample. On the loadings plot, compounds that are commonly contained in the samples will gather around the origin (0, 0), whereas group-specific compounds that characterize the difference between the groups will be located far from the origin. It should be noted that the axes of the loadings plot (and the scores plot) merely indicate mathematically invented values, which have no relation with the actual mass-to-charge ratio and retention time of the compounds. To obtain these items of information, the operator selects, through the input unit 26, one or more data points on the loadings plot that seem to represent the aforementioned characteristic compounds.

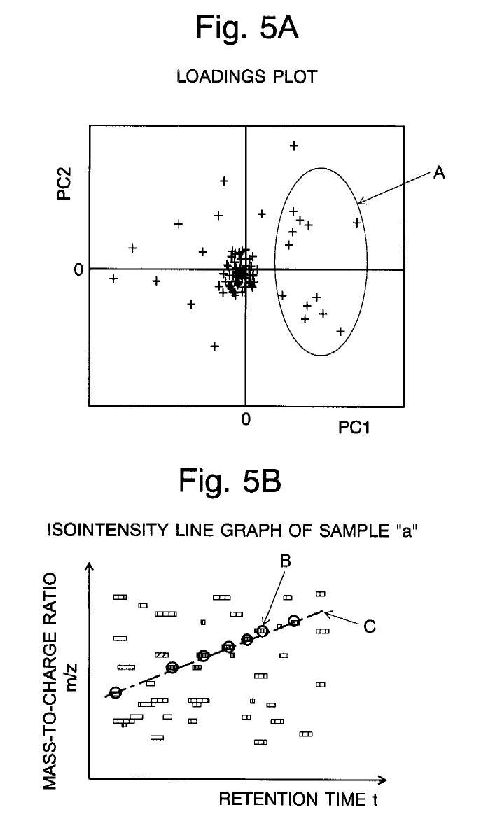

This selection can be achieved by specifying one data point after another on the loadings plot by a clicking operation of a mouse (or similar pointing device) included in the input unit 26, or by specifying a range including plural data points by a drag operation of the mouse. FIG. 5A shows an example of the latter selection method; the specified range is indicated by the frame A, which is elliptical in the present case.

When a specific range (or specific point) is selected on the loading plot, the selection information is fed through the I/O interface 40 to the component selector 37, which in turn identifies the selected compounds and determines, for each compound, which isointensity line graph contains the peak that corresponds to the compound concerned and where the peak is located on the graph. The indication symbol creator 38 creates a circular marking for each relevant point on the isointensity line graph. The superposing processor 39 superposes the markings on the corresponding isointensity line graph. FIG. 5B shows the resultant graph with the markings denoted by “B.” It should be noted that the marking may have any shape. In place of the marking, a color difference may be used for distinction from the surrounding area. In summary, any indicator can be used as long as it enables the operator to easily recognize which peaks correspond to the compounds selected on the loadings plot, i.e. on the displayed result of the multivariate analysis.

As stated earlier, each data point on the loadings plot in principle corresponds to one compound. However, a given sample does not always contain all the compounds corresponding to the data points present on the loadings plot. Therefore, in the state where an isointensity line graph for a given sample is displayed, the markings will be displayed for only the compounds that are contained in the given sample and also selected on the loadings plot. Meanwhile, any compound selected on the loadings plot should be contained in at least one sample, so that a marking corresponding to that compound will appear on the isointensity line graph for that sample.

In the example shown in FIGS. 5A and 5B, a frame A is specified on the loadings plot so that it surrounds plural compounds that seem characteristic (FIG. 5A). As a result, seven markings B are displayed on the isointensity line graph for a sample “a” (FIG. 5B). As can be clearly seen, the seven markings B are located along the upward-sloping line C, suggesting that the retention time and mass-to-charge ratio have a specific relationship with each other. This relationship can be described by the following primary expression:

m/z=a·RT+b,

where m/z is the mass-to-charge ratio, RT is the retention time, and a and b are constants. Such a relationship is typically found when a specific compound series including plural compounds with similar basic structures is present. Thus, it is possible to infer that the compounds which characterize the difference between the groups A and B belong to a specific compound series.

As described thus far, the LC/MS of the present embodiment clearly demonstrates the relationship between the result of a principal component analysis and that of LC/MS measurements (e.g. the isointensity line graphs in the previous example), enabling users to easily obtain information about the structure, nature and other properties of the samples on the basis of the principal component analysis result.

It should be noted that the embodiment described thus far is merely an embodiment of the present invention, and that any modification, adjustment, addition or the like properly made within the spirit of the present invention is also covered within the scope of the present invention. For example, the multivariate analysis operation method is not limited to the principal component analysis; it can be performed by any other multivariate analysis method, such as the partial least square (PLS) method, soft independent modeling of class analogy (SIMCA) method, or orthogonal PLS method. The present invention can also be applied to GC/MS systems as well as LC/MS systems as in the previous embodiment. The mass analyzer is not limited to the quadrupole type; it may be any type, such as a time-of-flight type or ion-trap type.

What is claimed is:

1. A chromatograph mass analysis data processing apparatus for processing data collected by a chromatograph mass spectrometer in which a chromatograph for separating a sample into components and a mass spectrometer for mass-analyzing the sample components separated by the chromatograph are combined, comprising:
a) a graph creator for creating, for each sample, a graph having a retention time and a mass-to-charge ratio on two axes on a plane with a signal intensity represented in contour or represented by an intensity-discriminable expression equivalent to the contour, on the basis of data collected by a chromatograph mass analysis of one or more samples;
b) a multivariate analysis result displayer for performing a multivariate analysis of the data collected by the chromatograph mass analysis of the aforementioned one or more samples, and for displaying a result of the multivariate analysis;
c) a point selector for allowing a user to select one or more data points, or a range including one or more data points, on the result of the multivariate analysis displayed by the multivariate analysis result displayer; and
d) a graph display processor for displaying the graph created by the graph creator, superposing an indicator on the graph to indicate which member or members of the data collected by the chromatograph mass spectrometer correspond to the aforementioned one or more data points selected by the point selector or included in the range selected by the point selector.

2. The chromatograph mass analysis data processing apparatus according to claim 1, wherein the multivariate analysis is performed by one of following methods: principal component analysis (PCA), partial least square (PLS), soft independent modeling of class analogy (SIMCA), and orthogonal PLS (O-PLS).

3. The chromatograph mass analysis data processing apparatus according to claim 1, wherein the result of the multivariate analysis displayed by the multivariate analysis result displayer is a loadings plot.

4. The chromatograph mass analysis data processing apparatus according to claim 2, wherein the result of the multivariate analysis displayed by the multivariate analysis result displayer is a loadings plot.

5. The chromatograph mass analysis data processing apparatus according to claim 1, wherein the indicator superposed on the graph by the graph display processor is a marking having a predetermined shape and size.

6. The chromatograph mass analysis data processing apparatus according to claim 1, wherein the indicator superposed on the graph by the graph display processor differs in color from a surrounding area.

7. The chromatograph mass analysis data processing apparatus according to claim 1, wherein the point selector is designed for users to select individual data points by an operation using a pointing device.

8. The chromatograph mass analysis data processing apparatus according to claim 1, wherein the point selector is designed for users to specify the aforementioned range by creating a frame of an appropriate shape and size by an operation using a pointing device.
